(19) United States
(12) Patent Application Publication
(10) Pub. No.: US 2022/0303273 A1
(43) Pub. Date: Sep. 22, 2022

(54) DEVICE AND METHOD FOR SELF-LEARNING INTERNET GATEWAY WITH INTERNET OF THINGS (IOT) DEVICE ISOLATION

(71) Applicant: INSEEGO CORP., San Diego, CA (US)

(72) Inventor: Mikko Jaakkola, San Diego, CA (US)

(21) Appl. No.: 17/207,493

(22) Filed: Mar. 19, 2021

(51) Int. Cl. H04L 29/06; H04L 12/24; H04W 12/08

(52) U.S. Cl. CPC H04L 63/10; H04L 41/12; H04L 63/0876; H04L 63/20; H04W 12/08; G16Y 30/00

(57) ABSTRACT

Systems and methods are provided for self-learning and Internet-of-Things (IoT) device isolation which can protect a network by communicatively isolating any malicious behavior that may be performed by the IoT devices. Thus, the impact of potentially compromised IoT devices can be mitigated by the disclosed systems and methods. A method can identify the IoT devices, and establish an isolated network to separate communication between the IoT device from a home network. It can be detected whether an IoT device on the isolated network is attempting to communicate with a computer device on the home network, and further determined whether the IoT device is authorized to communicate with this computer device on the home network. In cases where the IoT device is not authorized to communicate with the computer device on the home network, the IoT device can be automatically blocked from communicating with the computer device on the first network.

### DESCRIPTION OF RELATED ART

The present disclosure relates to security of distributed networked devices, including Internet of Things (IoT) devices.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one example of a network configuration including multiple Internet of Things (IoT) devices and an Internet gateway for implementing the disclosed self-learning and IoT device isolation techniques, according to some embodiments.

FIG. 2 is an example of a method for implementing the disclosed self-learning and IoT device isolation techniques, in accordance with some embodiments.

FIG. 3 is a block diagram of an example computing component or device for implementing the self-learning and IoT device isolation techniques, in accordance with one embodiment.

The figures are not exhaustive and do not limit the present disclosure to the precise form disclosed.

### DETAILED DESCRIPTION

Wireless communication, particularly wireless local area network (WLAN) technology, has become ubiquitous in the mobile computing environment. Some existing wireless networking standards, for example, Wi-Fi protocol IEEE (Institute of Electrical and Electronics Engineers) 802.11 can be used to provide close-proximity wireless connectivity between wireless devices. Additionally, newer wireless networking technologies, such as 802.11ah, have been developed that are capable of operating at longer ranges and having comparatively lower device power consumption than some existing wireless systems. These long-range, low power (LRLP) wireless technologies are usable to extend the communication range that is achieved with some legacy 802.11 wireless technologies, such as Wi-Fi and Bluetooth.

An example of such an environment is the Internet of Things (IoT), which extends networking capabilities to wide-ranging types of applications. Through the IoT framework, virtually any type of physical device, ranging from vehicles to thermostats, are capable of Internet based communication, providing information about the device itself or its surroundings, and/or may be controlled remotely via client devices over the Internet. However, such a wide range of devices, having disparate computing frameworks from different company platforms, creates challenges for implementing a universal security mechanism that can be used across the various current IoT implementations. Users can provide some level of protection, creating a personal Wi-Fi networks by using different Service Set Identifier (SSID) for IoT devices. However, this approach requires advanced knowledge for setting up each of the devices, which can be difficult for end users that are not tech savvy and can be cumbersome as the number of IoT devices on a network increases. For example, as the demand for home connectivity grows, a user would have to manually set up each IoT device in their home, which can range from appliances, laptop computers, security sensors, and the like. Some users can provide some security by employing switches for creating a virtual local area network (VLAN) between Wi-Fi access point and the rest of the network. Nonetheless, this approach can have great difficulty from many users, such as homeowners, that may not have extensive technological and/or networking knowledge. Firewalls can also be used for blocking the traffic to suspicious places, which would prevents IoT devices to communicate with these suspicious destinations. However, firewalls are typically used when the suspicious destinations are known. Accordingly, firewalls are effective when the suspicious destinations are known, but can leave the network vulnerable in the case where the suspicions destination is not known. Often times, network attacks come from an unknown source and/or a frequently changing source, and thus firewalls may not be optimal for protecting IoT devices. Furthermore, further firewalls fail to address the issue where a known IoT device is unknowingly trying to data mine the local network, or do some other local activities that are detrimental to the security of the network. The self-learning and IoT device isolation techniques, as disclosed herein, can provide protection to a network by communicatively isolating any malicious behavior that may be performed by the IoT devices on the network from other areas of the network, thereby mitigating the impact of potentially compromised IoT devices on the network's security. As a general description, the disclosed self-learning and IoT device isolation techniques function to: 1) automatically detect IoT devices from the general home electronics; and 2) isolate the IoT devices into it's a separate private network using heuristics that include device identity and internet traffic patterns. A key feature of the disclosed techniques is an autonomous device classification service that implements the detection aspects in order to ultimately protect the user network from IoT device exploitations.

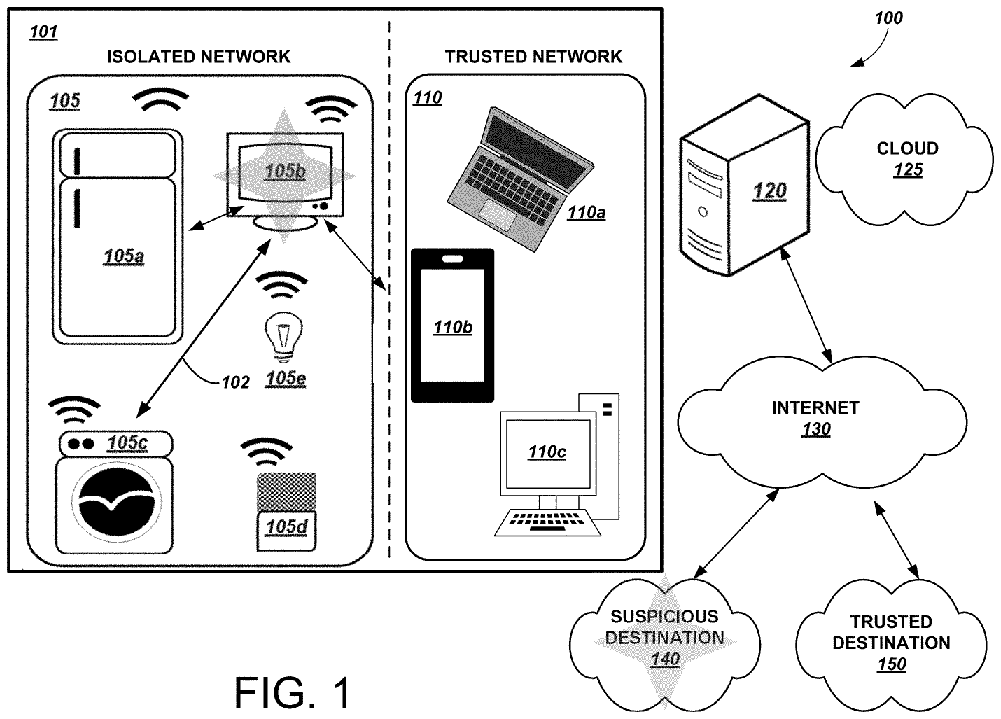

FIG. 1 shows an example of a communication system 100 including a gateway 120 for implementing the self-learning and IoT device isolation techniques as described herein. In FIG. 1, the system 100 includes a private network 101. As an example, a private network 101 can be employed to provide wireless connectivity for stationary, portable, and mobile electronic devices within accessible range to establish wireless communication links 102, or channels, supported by the network 101. The wireless communication network 101 includes components that interact with one another in order to provide an over-the-air (OTA) interface between various consumer electronic devices having IoT connectivity, also referred to as IoT devices. IoT connectivity generally refers to communicative connections between identifiable electronic devices within an Internet infrastructure, in accordance with IoT technology standards, such as the Open Connectivity Foundation (OCF) standard.

In the illustrated example, the private network 101 is configured as a communication network located within a certain vicinity, such as a home of a user, and providing wireless connections amongst various consumer electronic devices. Accordingly, FIG. 1 shows private network 101 in a configuration that is commonly referred to as a smart home environment. Many consumer electronic devices intended for home use, such as household appliances, are physically small devices that are designed to support low power, and low-complexity computing. In some embodiments, the plurality of IoT devices 105a-105e are devices using long range, low-power technologies to extend battery life to operate for greater lengths of time (e.g., years). In this case, communication links 102 can be implemented using a low-power wireless communication technology such as Bluetooth Low Energy (LE), and IoT devices 105a-105e can include Bluetooth LE antennas and protocol stacks.

For example, the plurality of IoT devices 105a-105e include various consumer electronic devices suited for in-home use, such as a refrigerator 105a, television 105b, washing machine 105c, micro-speaker 105d, and a light 105e. Consequently, some of the consumer electronic devices included in the plurality of IoT devices 105a-105e can have resource-limitations that limit the types of security mechanisms that can be programmed and/or implemented by these devices. Resource-limitations can include minimal memory, low central process unit (CPU) processing power, low CPU clock speed, and low-level software (e.g., no operating system). Moreover, each of the devices in the plurality of IoT devices 105a-105e can operate using a different platform corresponding to a particular manufacturer (or service provider) associated with that device. As a result, the plurality of IoT devices 105a-105e can be associated with a lack of uniformity in regards to communication (e.g., different communication protocol), due to the disparate platforms. Thus, with such limited capability, IoT devices 105a-105e may be more susceptible to malicious attacks from outside of the private network 101.

In addition, devices other than the IoT devices 105a-105e can be connected to the private network 101. In the example, private network 101 includes a laptop computer 110a, a smartphone 110b, and a desktop computer 110c. Generally, these computer devices 110a-11c have greater computing resources and greater processing complexity in comparison to the IoT devices 105a-105e. The computer devices 110a-11c can be configured to include dedicated networking security mechanisms, because the devices typically do not have the same type of resource-limitations as the IoT devices 105a-105e. For instance, the laptop computer 110a can have an anti-virus software and/or other forms of security applications installed thereon, which provides protection for the device 110a from any malicious attacks from outside of the private network 101. Consequently, the computer devices 110a-11c are generally less vulnerable to malicious attacks than the IoT devices 105a-105e counterparts on the private network 101.

According to the embodiment, the gateway 120 can be configured to provide a solution for malicious attacks on the less sophisticated IoT devices 105a-105e that may cause its behavior to be malicious towards other devices connected in the same network, namely private network 101. As shown in FIG. 1, the IoT devices 105a-105e and computing devices 110a-11c are all connected through the private network 101 via the gateway 120. The gateway 120 can implement the self-learning and IoT device isolation techniques, and thus may function with a cloud 125 that can provide mechanisms and efficiencies in order to support these capabilities. For instance, the cloud 125 can store look-up tables and implement other machine learning/artificial intelligence (ML/AI) operations.

As a result of the self-learning and IoT device isolation techniques, the gateway 120 can effectively split the private network 101 into two networks: 1) an isolated network 105 that includes the IoT devices 105a-105d; and 2) a trusted network 110 that includes the computing devices 110a-110c. According to the embodiments, the gateway 120 is configured to automatically identify and classify which devices are the IoT devices 105a-105e on the private network 101 based on one or more parameters, including but not limited to: 1) the MAC address or physical device ID; 2) traffic destination; and 3) type of traffic requested. The autonomous classification can be considered as the “self-learning” aspects of the disclosed techniques, as the gateway 120 can autonomously learn, or identify, which of the devices on the network are particularly IoT devices without human intervention. In other words, the gateway 120 has the capability to learn on its own the types of devices that are connected to the network. After the gateway 120 has identified the devices that are the IoT devices 105a-105e on the private network 101, the gateway can then place the IoT devices 105a-105e into the isolated network 105 as shown in FIG. 1. Furthermore, the other devices (e.g., devices that are not IoT devices), shown as computer devices 110a-110c, can be placed into the trusted network 110. As a result, the gateway 120 can provide a layer of protection by separating the IoT devices 105a-105e that are more vulnerable to a malicious attack on the isolated network 105, in a manner that has them communicatively divided away (indicated by the dashed line) from the computer devices 110a-110c that are generally safer and can be trusted. This separation can be accomplished by: having the IoT devices 105a-105e reside on a “trusted” network IoT network; having the IoT devices 105a-105e all reside on an isolated network 105 where all of the IoT devices share the same network (as shown in FIG. 1), or having each of the IoT devices 105a-105e configured on its own private network (e.g., isolating each IoT device individually). In some cases, IoT devices 105a-105e of the same platform type, brand, or function could share the isolated network 105.

The isolated network 105 can be implemented via a software-level configuration. For instance, the isolated network 105 can be implemented as a virtual LAN (VLAN) or complete network isolation for the IoT devices 105a-105e. For example, a virtual Wi-Fi network for IoT devices 105a-105e can be created by using the same SSID for the IoT devices 105a-105e while Trusted Network devices 110a-110c use different SSID. The device outcome can be achieved by using different LAN-port IoT devices that profits the traffic being echoed to Trusted Network. Additionally, the gateway 120 can perform packet filtering in a manner that allows the authorized devices to communicate with each other by filtering the other traffic. Also, in some embodiments, a user, such as the home owner, can get notified when one of the IoT device 105a-105e attempts to communicate with another device, and is notified when any new device is added in the private network 101.

In another implementation, the isolated network 105 can be implemented via a hardware-level configuration. For instance, the isolated network 105 can be implemented by configuring certain physical ports (e.g., associated with an IoT device) to be restricted to communication only to other devices within the isolated network 105. For example, the gateway 120 (or other network device such as a switch) can be configured to automatically direct traffic from a specific physical port, for instance a physical LAN port corresponding to IoT device 105a, to a list of other IoT devices 105b-105e on the isolated network 105 that are identified by their respective network IDs.

FIG. 1 also shows that the private network 101 can be connected to a trusted destination 150 and a suspicious destination 140 via a wide area network (WAN). The WAN is depicted as Internet 130. The trusted destination 150 can be a legitimate endpoint for the IoT device 105a-105e, such as an IoT Hub, that is remotely located from the private network 101. Alternatively, a suspicious destination 150 can be the source of a malicious attack, such as a data harvester.

As an operational example, the IoT devices 105a-105e are deployed at a home, where they are connected to the same private network 101 as the standard computer devices 110a-110c. The IoT devices 105a-105e are often operating in the background, for instance measuring temperature, taking video surveillance, and the like. Nonetheless, the IoT devices 105a-105e also possess some of the same capabilities as computer devices 110a-110c, such as having direct access to operations on the private network 101 at the home. As a result, the IoT devices 105a-105e also have access to the user's home and personal information. In an attack, the suspicious destination 140 may install malware on one or more targeted IoT devices 105a-105e on the private network 101. In the illustrated example, the IoT device 105b has fallen victim to a malicious attacked (indicated by star), where malware transmitted from the suspicious destination 140 has been installed on the IoT device 105b. After it has been infected, the suspicious destination 140 can cause the IoT device 105b to perform undesired operations within the private network and/or the user's home. For example, the malware on the IoT device 105b can cause the television to act as a rogue agent, such as maliciously communicating and/or intercepting data from other IoT devices 105a, 105c, 105d, 105e or using its tv components to obtain unintended video/audio surveillance on the home.

Additional examples of undesirable operations of the IoT device 105b under attack from the suspicious destination 140 can include, but are not limited to: network data harvesting; Denial of Service Attacks (DoS); leaking security credentials; unintended home automation operations (e.g., unknowingly opening backdoors, turning off alarms);attacking other network devices (e.g., install malware thereon). In other words, gateway 120 can be configured to circumvent several different traffic patterns related to the IoT device 105b that may be characteristic of undesirable or suspicious behavior, including:
Network flooding (e.g., Distributed Denial of Service)
Atypical device operations
   an IoT device (e.g., garage door opener) attempting to find what devices are in on the home LAN
   an IoT device (e.g., garage door opener) attempting to identify the enabled services through port-scanning in my home network
   an IoT device (e.g., garage door opener) attempting to make SSH/telnet sessions with any of other devices on the home LAN to gain control and/or manage
Unexpected communication destinations

For example, a consumer Wi-Fi access point can be turned to be part of botnet that then takes part in Distributed Denial of Services Attacks (DDoS). According to the embodiments, the gateway 120 can isolate the infected IoT device 105b on the isolated network 105, and away from the computer devices 110a-110c that are on the trusted network 110. Thus, the gateway 120 can block attempts by the infected IoT device 105b to communicate with any of these computer devices 110a-110c on the trusted network 110. Even further, the gateway can detect whether the infected IoT device 105b is responsible for flooding in the private network 101, and can subsequently eject (or blocked) the infected IoT device 105b from the private network 101 mitigating any further degradation to the network.

In some embodiments, the gateway 120 also has the capability to send various notifications to a user of the home private network 101. For instance, the gateway 120 can provide notifications to a computer device of a homeowner (via push notification to a software application or electronic message) in order to make the user aware of a device that has been newly added to the home private network or to make the user aware of that one of the IoT devices 105a-105 is attempting to communicate with the computer devices 110a-110c on the trusted network 110. In response to receiving a notification from gateway 120, the user can then have an option to let the new device become part of the trusted network 110 or to authorize/deny the communication from the IoT devices 105a-105 outside of the isolated network 105.

In addition, the gateway 120 can also detect when one of the identified IoT devices 105a-105e is flooding the home private network 101. According to this embodiment, the gateway 120 can have some form of knowledge of the type of IoT device and an amount of traffic/data rate that is nominal for the particular type of IoT device. For example, the gateway 120 can determine that a light 105e should not be transferring megabytes of data and may be flooding the on the home private network 101 as a malicious activity, because an IoT device of this type typically transmits less than hundreds of bytes. When unusual activity based on data rate (e.g., flooding) is detected by the gateway 120, a trusted user can be notified and the corresponding IoT device can be ejected and/or blocked from the network. Referring back to the example, the gateway 120 can notify the home owner that the light 105e is suspected of flooding the network, and the user can provide a user input that results in the gateway 120 blocking the light 105e from communicating with any other device on the home private network 101 (on the isolated network 105 or the trusted network 110). In an embodiment, the gateway 120 can also automatically block the IoT device that has been suspected of flooding the network. The automatic block performed by the gateway 120 can be temporary. For instance, the block can be removed, in response to a user clearing the device for communicating with the network again. Accordingly, the disclosed self-learning and IoT device isolation techniques can prevent a DoS attack, as any detected suspicious activity of an isolated IoT device triggers an autonomous protection activity on the home private network 101. Protection activities that the gateway 120 can be configured to perform, in accordance with the disclosed self-learning and IoT device isolation techniques includes, but it not limited to:
Preventing IoT devices querying information and thus seeing traffic meant for other devices in the physical network
Preventing IoT devices sending traffic (e.g., DDoS traffic) to the protected local devices through filtering or kicking the device out of the network
Allowing IoT devices to only enable authorized services with the local devices
Preventing traffic flooding
Notifying the network owner of abnormalities on a network

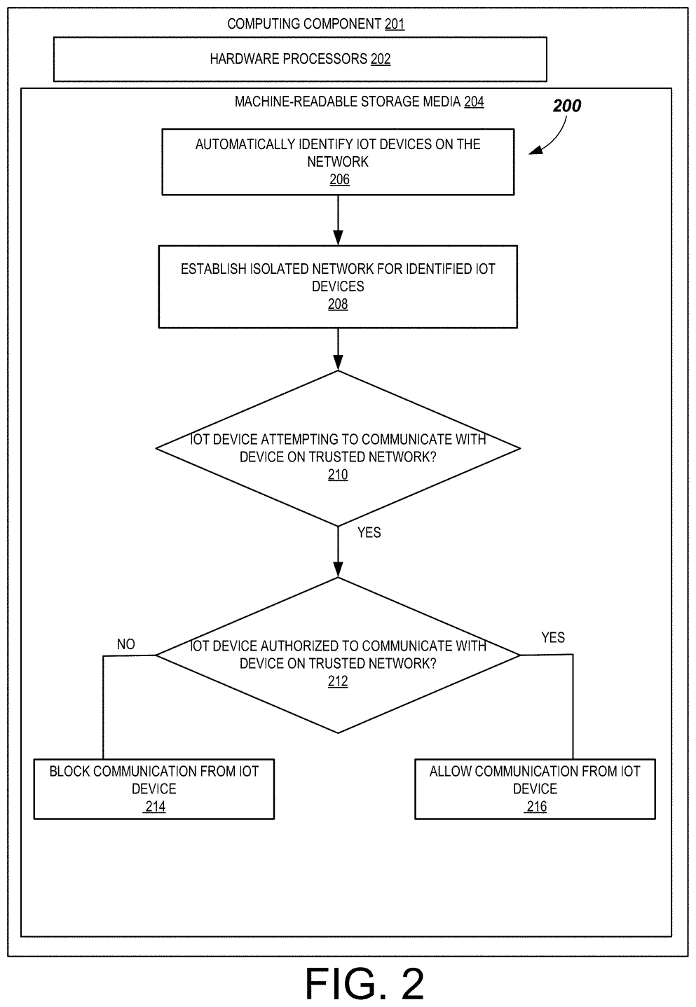

FIG. 2 illustrates a flow chart of a process 200 for implementing the disclosed self-learning and IoT device isolation techniques. Furthermore, FIG. 2 shows process 200 as a series of executable operations stored on a machine-readable storage medium 204 performed by hardware processors 202, which can be the main processor of a computing component 201. For example, the computing component 201 can be a gateway device described at least in reference to FIG. 1. In operation, hardware processors 202 execute the operations of process 200, thereby implementing the disclosed techniques.

In the example, the process 200 begins at operation 206 where devices that are IoT devices can be automatically identified. For instance, operation 206 can involve identifying which devices that are currently connected to a private network are the IoT devices, as oppossed to conventional computer devices, based on analyzing each device's physical device ID, traffic destination address, type of traffic/service that is requested, and the data transfer protocols used. According to the embodiments, the attributes that are analyzed in order to classify the IoT devices includes, but are not limited to: 1) the physical device id (MAC address, Wi-Fi address, BT address/name, etc.); 2) traffic destination; and 3) the type of traffic/service that is requested. In some embodiments, operation 206 continues until each device that is currently on the network has been identified as either a IoT device or as a non IoT devices (e.g., computer devices).

Identifying whether a devices is IoT devices can be implemented through Organizationally Unique Identifier (OUI) stored in MAC-address. The OUI identifies an OEM associated with manufacturing the device. Also, some protocols convey the device ID through higher layer protocols (e.g., BT device name). For example, when a device first connects to the cloud, the device communicates an identifying string such as UEAgent string as part of the request. By analyzing the identifying string, a device type can be tied to the device's physical network address or its name.

Additionally, identifying whether a device is an IoT device can be implemented by monitoring device calls. For instance, an IoT device can call home to its associated IoT Hub and/or associated cloud services. This information is available through the destination addresses the device is trying to reach, for example through the TCP SYN package (starts TCP/IP connection) that are part of the protocol headers. A reverse-look-up table can be used to map IP-addresses to services (in clear). When a service is known to host IoT clouds, this can indicate that the device is an IoT device (e.g., IoT device likely calling home to an IoT cloud service). In most cases, it is enough to have IP-address with ranges to identify the allowed connections. The look-up table can be populated through a service that may reside in the device or cloud.

Identifying whether a device is an IoT device can be implemented by monitoring the data that the device transfers to the network. For example, there are communication protocols that are configured for use by IoT devices, such as MATT, AMQP. Accordingly, operation 206 can involve monitoring the data communicated by a device in order to determine whether a IoT protocol is being used. Detecting data that is formatted in accordance with an IoT protocol can indicate that the corresponding device is an IoT device.

After each IoT device on the network has been properly identified, or otherwise categorized, the process 200 continues to operation 208. At operation 208, an isolated network can be established in order to communicatively separate the IoT devices from the non-IoT devices that are on the network. In some embodiment, the isolated network is implemented as a virtual network that includes all of the IoT devices identified in previous operation 206. The virtual network can restrict the access and/or communication of these IoT devices that reside thereon certain other devices and/or services that are not on the isolated network. In another embodiment implementing a more strict isolation policy, each IoT device has its own respective virtual local area network (VLAN). For example, there can be multiple isolated networks, or VLANS. Each individual isolated network will only include a single IoT device, as opposed to one isolated where all of the IoT devices reside (shown in FIG. 2). In this embodiment, an IoT device may only have access to the Internet in its own individual isolated network. Since many IoT devices, like garage door openers, use the cloud for its operations, the strict isolation policy generally has no impact on their functionality or performance. As previously described, by having the IoT devices on the isolated network (e.g., VLAN), the configuration can prevent these IoT devices from communication with other devices in the network (that are not on the isolated network) without authorization.

As an example, operation 208 isolates the IoT devices by creating a VLAN (only for the identified IoT devices) within a home network. The IoT device isolation prevents these IoT devices from directly communicating with other non-IoT computer devices that are accordingly not on the VLAN, such as the homeowner's laptop computer. This configuration, having an isolated VLAN designated for the IoT devices, protects the home network from the more vulnerable IoT devices in a manner that does not prevent the IoT devices (or the non-IoT computer device) from nominal operations. For instance, a secure garage door opener would just use the local home Wi-Fi to access its vendor's cloud service, and listen to commands from any controlling client devices. In this case, a commanding client device can be a user's smartphone that is also connected to the home network with the garage door opener. However, it is not required for the commanding client device to directly communicate with garage door opener. The commanding client device and the IoT device, namely the garage door opener, can communicate with the cloud service via the Wi-Fi for commands, which providing end-to-end security. Accordingly, operation 208, which establishes an isolated network for the garage door opener and other IoT devices and restricts their communication (outside of the isolated network) would not cause the garage door opener to become inoperable. Operation 208 does effectively safeguard the home network, including the commanding client device, in the case some malicious third party manages to install rogue firmware into the garage door opener that would try to perform illicit actions in the user's home network (e.g., data mining, hacking into other IoT devices and home electronics).

As alluded to above, a key aspect of operation 208 is automation. In detail, establishing the isolated network (in order to achieve the disclosed IoT device isolation configuration) is performed automatically on the behalf of the user. The user, for instance a home owner, does not need to have technical knowledge pertaining to creating and/or configuring a network. Therefore, process 200 additionally provides an ease of use, and mitigates damage that may result from any potential user error (e.g., misconfiguring the network) associated with requiring a layman to manually performing such a network configuration.

In another embodiment, operation 208 involves creating an isolated network that includes IoT devices having shared characters. For instance, an isolated network can be established for IoT devices having the same SSID. In operation, when a client device probes an IoT device, an access point typically responds with an IoT BSSID to force the IoT device to connect into particular access point. A router can then keep all of the traffic inside of the isolated network (e.g., VLAN) that corresponds to the BSSID to cross-communicate. By being within the isolated network for the BSSID, the IoT device will not be able to capture any multi-cast and/or broadcast traffic.

In some cases, there can be a need for some level of interactions between isolated IoT devices and other computer devices that are on the network. Accordingly, at operation 210, the process 200 can determine whether an IoT device that is currently restricted on the isolated network is attempting to communicate to another computer device that is outside of the isolated network (e.g., trusted part of the home private network). When such an attempt is detected (“Yes” in FIG. 2), then the process can proceed to 212 in order to authorize the IoT device prior to allowing it to communicate with a computer device that is trusted and residing on part of the network that is not isolated. At operation 212, another conditional check is performed to determine whether the connection and/or service being attempted by the IoT device is authorized. According to the some embodiments, the decision made in operation 212 can be based on defined rules or based on user input. For instance, defined rules can include a list of acceptable computer devices and services (not on the isolated network) that are deemed authorized for each isolated IoT device, respectively. Also, the defined rules can include acceptable interactions. Decisions based on acceptable interactions involve more of an assessment, for instance analyzing various factors relating to the communication (as opposed to explicitly listing each authorized device various and/or service).

In some embodiments, operation 212 can perform a look-up (or comparison) to a defined list of acceptable computer devices and/or services for the IoT device that is attempting the communication. That is, by employing the defined list of acceptable computer devices and/or services, only authorized connections (and services) from an IoT device are allowed to cross the logical barrier outside of the isolated network in order to communicate with another computer device. In the case where the communication attempted by the IoT is intended for a computer device that on its corresponding acceptable computer devices and/or services list, then the communication is determined to be authorized at operation 212. Then, the process 200 continues to operation 216, where the communication from the IoT device allowed. An authorized communication from an IoT device may be considered within the nominal operation of the IoT device, such as light communicating with a laptop computer device of the home owner that is commonly used to control the lighting within the home. Thus, when the process 200 successfully determined that a communication is authorized, even if the communication is outside of the isolated network, it has less of a potential of being suspicious activity of an infected or compromised IoT device that would also jeopardizes the security of the trusted devices. In other words, even if the IoT device is not a completely trusted device, this particular communication from the IoT device may be trusted. In the embodiments, operation 216 can involve allowing the communication and/or service via packet filtering (e.g., packets from authorized traffic are allowed to proceed to destination device).

Alternatively, in the case where the attempted communication by the IoT device is not authorized, then the process 200 moves to operation 214 where the communication is blocked. By blocking the communication, operation 214 ensures that the IoT device does not communicate outside of the isolated network, in this instance, and prevents unauthorized access to a trusted computer device. In some embodiments, blocking an authorized communication from an unauthorized IoT device can be accomplished through per packet filtering. For instance, in response to a communication being deemed unauthorized at operation 212, packets in the traffic from the IoT device are filtered in a manner that does not allow the packets to be received by the destination computer device, which is outside of the isolated network. Accordingly, the communication is effectively blocked in operation 214 by filtering out (or dropping) packets of the unauthorized traffic (e.g., packets from unauthorized traffic are blocked from proceeding to destination device).

Referring back to operation 212, determining whether an attempted communication from an IoT device is authorized can involve an awareness with respect to what devices, IoT device and non-IoT computer devices, should interact with one another. In other words, it can be assumed that devices which share similar characteristics, such as the same manufacture, seller, brand, and the like, are designed for some level of interoperability. Thus, with respect to the embodiments, communication between an isolated IoT device and a computer device outside of the isolated network both from the same manufacture, for instance, may be deemed as an acceptable interaction. As an example, there may be multiple devices purchased from the same consumer site, for instance Amazon™, that are being used on the network. Thus, there may be instances when communication between these brand of Amazon™ devices is an acceptable interaction. Accordingly, operation 212 may determine that communication between an IoT device from Amazon™ and a smartphone (not on the isolated network) that has an Amazon™ application installed thereon is authorized (devices that should interact with each other). As a result, process 200 may proceed to operation 216 and allow the isolated IoT device and the trusted smartphone to communicate with each other. However, in the case where the Amazon™ IoT device attempts to communicate outside of the isolated network with a computer device that does not share its Amazon type, operation 212 can determine that this is an authorized communication (devices that should not interact with each other). Subsequently, process 200 may move to operation 214 and prevent the Amazon™ IoT device from communicating with the trusted computer device that is not from Amazon™. As alluded to above, acceptable device interactions can involve detecting similarities between devices that are based on various factors, such as: device type; device manufacture; device vendor; device functions; communication protocol; and the like. For example, and IoT device and a computer device that are using the same communication protocol can also suggest that the devices are intended to interact with one another (e.g., not malicious activity), and thus can be deemed an acceptable interaction and/or an authorized communication by operation 212.

The determination at operation 212 can be based on defined rules, such as acceptable interactions, as described above. In some cases, operation 212 can involve user input, received from an end-user, that ultimately authorizes the communication from the IoT device. As an example, a client device, such as a smartphone can have a mobile software application (app) installed that allows the user to selectively authorize a communication from an isolated IoT device on the home private network. According to this embodiment, a user can receive a notification that is displayed on their smartphone via that app showing that an IoT device is attempting to communicate with another computer device this is not on the isolated network. The app can also provide a user interface, such as a widget that includes a clickable icon on the smartphone screen or another form of user interaction (pressing a device button) which allows the user to enter input. The user input can select whether the communication from the IoT device is authorized or unauthorized to be received by the trusted computer device. As an example, the app can display a notification on the touchscreen of a smartphone that an IoT device, such as a garage door opener, is trying to communicate with the laptop computer device (that is trusted and not on the isolated network). Further, the notification screen can include a region for the user to touch on the smartphone to selectively authorize the communication from the garage door opener which would cause the process to proceed to operation 216 and allow the communication. Alternatively, by touching a different region on the notification screen, the user can select that the garage door opener is unauthorized, which moves the process 200 to operation 214 which blocks the communication. Thus, in the example, if the garage door has been compromised and manipulated by a malicious attacker to function as a rogue agent on the home private network, a user can have the knowledge that the garage door was not set up to communicate with their laptop (the garage door now attempting this communication is suspicious). The process 200 can apply the user's knowledge by receiving user input at operation 212 in a manner that can authorize or deny the attempted communication from the IoT device.

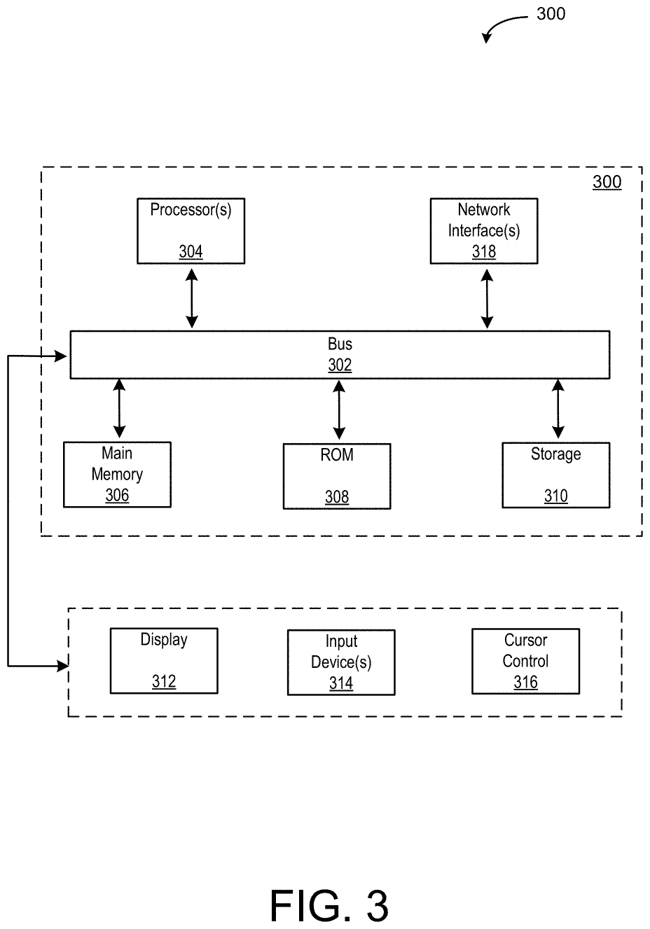

FIG. 3 is a block diagram of an example computing syster system or device 300 where various of the embodiments described herein may be implemented. The computer system 300 can implement the self-learning and IoT device isolation techniques, as disclosed herein. For instance, the computer system 300 can be embodied as gateway (shown in FIG. 1) or as another computer device that is capable of performing the disclosed techniques.

As shown, the computer system 300 includes a 302 or other communication mechanism for communicating information, one or more hardware processors 304 coupled with bus 302 for processing information. Hardware processor(s) 304 may be, for example, one or more general purpose microprocessors.

The computer system 300 also includes a main memory 306, such as a random access memory (RAM), cache and/or other dynamic storage devices, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

The computer system 300 further includes a read only memory (ROM) 308 or other static storage device coupled to bus 302 for storing static information and instructions for processor 304. A storage device 310, such as a magnetic disk, optical disk, or USB thumb drive (Flash drive), etc., is provided and coupled to bus 602 for storing information and instructions.

The computer system 300 may be coupled via bus 302 to a display 312, such as a liquid crystal display (LCD) (or touch screen), for displaying information to a computer user. An input device 314, including alphanumeric and other keys, is coupled to bus 302 for communicating information and command selections to processor 604. Another type of user input device is cursor control 316, such as a mouse, a trackball, or cursor direction keys for communicating direction information and command selections to processor 304 and for controlling cursor movement on display 312. In some embodiments, the same direction information and command selections as cursor control may be implemented via receiving touches on a touch screen without a cursor.

The computing system 300 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor(s) 304 executing one or more sequences of one or more instructions contained in main memory 306. Such instructions may be read into main memory 306 from another storage medium, such as storage device 310. Execution of the sequences of instructions contained in main memory 306 causes processor(s) 304 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 302. Transmission media can also take the form of acoustic or light waves, such as those generated during radio-wave and infra-red data communications.

The computer system 300 also includes a communication interface 318 coupled to bus 302. Network interface 318 provides a two-way data communication coupling to one or more network links that are connected to one or more local networks. For example, communication interface 318 may be an integrated services digital network (ISDN) card, cable modem, satellite modem, or a modem to provide a data communication connection to a corresponding type of telephone line. As another example, network interface 318 may be a local area network (LAN) card to provide a data communication connection to a compatible LAN (or WAN component to communicated with a WAN). Wireless links may also be implemented. In any such implementation, network interface 318 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 318, which carry the digital data to and from computer system 600, are example forms of transmission media.

The computer system 300 can send messages and receive data, including program code, through the network(s), network link and communication interface 318. In the Internet example, a server might transmit a requested code for an application program through the Internet, the ISP, the local network and the communication interface 318.

The received code may be executed by processor 304 as it is received, and/or stored in storage device 310, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 300.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
identifying a plurality of Internet-of-Things (IoT) devices connected to a first network;
establishing a second network including the plurality of identified IoT devices, wherein the second network separates communication between the IoT device from the first network;
detecting whether one of the plurality of IoT devices on the second network is attempting to communicate with a computer device on the first network;
determining whether the IoT device is authorized to communicate with the computer device on the first network; and
in response to determining that the IoT device is not authorized to communicate with the computer device on the first network, automatically blocking the IoT device from communicating with the computer device on the first network.

2. The method of claim 1, wherein identifying the plurality of IoT devices is based on at least one of: a physical device identifier, a traffic destination address, a type of requested traffic/service, and a data transfer protocol.

3. The method of claim 2, wherein the physical device identifier comprises at least one of: a media access control (MAC) address, a Wi-Fi address, and a Bluetooth (BT) address.

4. The method of claim 1, wherein establishing the second network comprises creating a virtual local area network (LAN) that restricts access of the plurality of IoT devices to certain services and prevents unauthorized communication with the computer device on the first network.

5. The method of claim 4, wherein the VLAN is a virtual Wi-Fi network for the plurality of IoT devices having the same Service Set Identifier (SSID) assigned to the plurality of IoT devices.

6. The method of claim 1, wherein determining whether the IoT device is authorized to communicate with the computer device on the first network is based on one or more defined rules.

7. The method of claim 6, wherein the one or more defined rules comprises at least one of: acceptable computer devices and/ services, and acceptable interactions.

8. The method of claim 7, wherein the acceptable interactions are based on determining one or more shared factors between the IoT device and the computer device.

9. The method of claim 8, wherein the one or more shared factors comprise: a device type; a device manufacture; a device vendor; device functions; and a communication protocol.

10. The method of claim 1, wherein determining whether the IoT device is authorized to communicate with the computer device on the first network is based on user input.

11. The method of claim 1, wherein the method further comprises:
in response to detecting whether one of the plurality of IoT devices on the second network is attempting to communicate with a computer device on the first network, notifying a computer device associated with a trusted user of the attempted communication.

12. The method of claim 7, wherein the method further comprises:
detecting whether a new computer device is attempting to connect to the first network; and
in response to detecting that a new computer device is attempting to connect to the first network, notifying the user and receiving a user input to allow or deny adding the new computer device to the first network.

13. The method of claim 1, wherein the method further comprises:
detecting whether one of the plurality of IoT devices is transferring data at a rate greater than a defined data rate corresponding to the IoT device; and
in response to detecting that the IoT device is transferring data at a rate greater than a defined data rate, notifying the user and receiving a user input from the user to allow or block communication from the IoT device to the first network.

14. The method of claim 1, wherein establishing the second network comprises configuring a physical port corresponding to one of the plurality of IoT devices to automatically direct traffic to other IoT devices of the plurality of IoT devices to prevent unauthorized communication with the computer device on the first network.

15. A system, comprising:
a home network comprising a plurality of devices; and
a network device comprising a non-transitory machine-readable storage medium encoded with instructions executable by a hardware processor to perform a method for Internet of Things (IoT) device isolation, the method comprising:
identifying whether each of the plurality of devices is an IoT device or a trusted computer device;
establishing an isolated network on the home network, wherein the isolated network includes the identified IoT devices and separates communication between the IoT devices from the trusted computer devices on the home network;
detecting whether an IoT device on the isolated network is attempting to communicate with a computer device on the home network;
determining whether the IoT device is authorized to communicate with the computer device on the home network; and
in response to determining that the IoT device is not authorized to communicate with the computer device on the home network, automatically blocking the IoT device from communicating with the computer device on the home network.

16. The system of claim 15, wherein the isolated network comprises a virtual local area network (LAN) that restricts access of the IoT devices to certain services and prevents unauthorized communication with the computer device on the home network.

17. The system of claim 15, wherein the isolated network comprises physical ports of the network device programmed to automatically direct traffic from an IoT device to other IoT devices to prevent unauthorized communication with the computer device on the first network.
